(19) United States
(12) Patent Application Publication
(10) Pub. No.: US 2010/0110917 A1
(43) Pub. Date: May 6, 2010

(54) Method, Apparatus and Computer Program Product For Adaptive Reference Symbol Placement

(75) Inventors: Xiang Guang Che, Beijing (CN); Chun Yan Gao, Beijing (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/532,168

(22) PCT Filed: Mar. 13, 2008
(86) PCT No.: PCT/IB2008/050927

§ 371 Date: Sep. 20, 2009

(30) Foreign Application Priority Data
Mar. 20, 2007 (US) 60895839

(51) Int. Cl. H04J 1/16

(52) U.S. Cl. 370/252

(57) ABSTRACT

A method, apparatus and computer program product are provided that determine the length of an idle period, such as the idle period preceding a DL-to-UL switch point, and then insert a symbol including reference signal(s) (RS) at a position within a downlink slot that varies based upon the length of the idle period. A method, apparatus and computer program product are also provided according to another aspect that determine the length of an idle period, receive a plurality of symbols within a downlink slot and then recognize a symbol including RS at a position within the downlink slot that varies based upon the length of the idle period. Accordingly, the method, apparatus and computer program product permit the position of the symbol including RS within a downlink slot to be varied while still providing the reference signals that are required in order to permit accurate recovery of the data.

### FIELD OF THE INVENTION

Embodiments of the present invention relate generally to wireless communication technology and, more particularly, relate to an apparatus, method and a computer program product for facilitating adaptive placement of a reference symbol based upon the length of the idle period.

### BACKGROUND OF THE INVENTION

In contrast to a frequency division duplex (FDD) system in which the downlink from a base station to the user equipment is at a first frequency and the uplink from the user equipment to the base station is at a second frequency different than the first frequency, a time division duplex (TDD) system employs the same frequency for both the downlink and the uplink between the base station and the user equipment. One TDD system that is currently being developed is the evolved universal mobile telecommunication system (UMTS) terrestrial radio access network (E-UTRAN). The E-UTRAN, which is also known as long-term evolution (LTE) or 3.9G, is aimed at upgrading prior technologies by improving efficiency, lowering costs, improving services, making use of new spectrum opportunities and providing better integration with other open standards.

In E-UTRAN, as well as other TDD systems, an idle period is required when switching from downlink operation to uplink operation, i.e., DL-to-UL switching, and when switching from uplink operation to downlink operation, i.e., UL-to-DL switching. In this regard, the idle period is required for DL-to-UL and UL-to-DL switching since the radio transceivers of the user equipment and the base stations, e.g., eNodeBs in E-UTRAN terminology, cannot simultaneously transmit and receive. In this regards, efforts by a common transceiver to support both an uplink and a downlink would result in undesirable self-interference. Additionally, an idle period may be utilized to avoid interference between the uplink and downlink of different mobile terminals, e.g., UE-to-UE interference, and between the uplink and downlink of different base stations, e.g., eNodeB-to-eNodeB interference in E-UTRAN terminology.

An idle period is generally only required proximate a DL-to-UL switching point since the idle period required by a base station, e.g., a node B, proximate a UL-to-DL switching point is created by a timing advance means. Moreover, in terms of the idle period required at the DL-to-UL switching point, the length of the idle period may vary. For example, base stations designed to support a larger cell size generally require longer idle periods due to the correspondingly larger potential propagation delays between the base stations and the user equipment. However, the length of the idle period is generally subject to definition by the operator or service provider based upon its preference with respect to the length of the idle period.

By way of example, an E-UTRAN specifies that the last symbol(s) in the slot immediately preceding a DL-to-UL switch point is reserved for an idle period. In this regard, the physical layer for an E-UTRAN is generally configured such that each 10 millisecond radio frame is divided into 10 equally sized subframes that are each assigned for either downlink or uplink transmission. Each subframe, in turn, includes two equally-sized slots with each slot including seven symbols. As noted above, the number of symbol(s) that are reserved at the end of the slot preceding a DL-to-UL switch point for the idle period is defined by the operator, such as based upon the cell size and/or other parameters. In addition to defining the placement of the idle period, an E-UTRAN specifies that reference symbols are to be located in the first and fifth downlink orthogonal frequency division multiplexing (OFDM) symbols in each slot for a downlink employing a normal cyclic prefix (CP). Alternatively, for a downlink employing an extended CP, the E-UTRAN specifies that reference symbols are to be located in the first and fourth downlink OFDM symbols of each slot. In this regard, reference signals (RS) are mixed with data to create the designated symbol, generally referred to as a reference symbol or a pilot symbol, and facilitate channel estimation by the recipient, such as the user equipment, that permits the user equipment to more accurately recover the transmitted data.

As an example of an E-UTRAN system utilizing a normal CP, FIG. 1 depicts the two slots of a subframe with the symbols of the last slot 2 that precedes the DL-to-UL switch point shown in more detail. In this regard, the first and fifth symbols 4, 6 include reference signals while the sixth and seventh symbols 8 are muted to provide the requisite idle period.

In some instances, such as in instances in which the cell size is relatively large, three or more symbols may be required to create the necessary idle period. In these instances, the last reference symbol of a slot will not be transmitted since the fifth symbol which would typically include the last reference symbol in the context of a normal CP will, instead, be muted so as to serve as a portion of the idle period. By failing to transmit the last RS in the slot, the downlink performance may be degraded since the user equipment will have a less accurate estimation of the channel and, accordingly, potentially be less successful or at least less accurate in recovering the data transmitted to the user equipment.

Accordingly, it would be desirable to continue to permit accurate channel estimation even in instances in which the idle period is longer, such as three or more symbols in length, in order to accommodate larger cell sizes, for example.

### BRIEF SUMMARY OF INVENTION

A method, apparatus and computer program product are therefore provided that determine the length of an idle period, such as the idle period preceding a DL-to-UL switch point, and then insert a symbol including reference signal(s) (RS) at a position within a downlink slot that varies based upon the length of the idle period. For example, an apparatus of this embodiment may be comprised of a base station, e.g., an eNodeB in E-UTRAN terminology, that includes a processing element configured to determine the length of the idle period and to then insert a symbol including RS at a position within the downlink slot that varies based upon the length of the idle period.

According to another aspect of the present invention, a method, apparatus and computer program product are provided that determine the length of an idle period, receive a plurality of symbols within a downlink slot and then recognize a symbol including RS at a position within the downlink slot that varies based upon the length of the idle period. For example, the apparatus of one embodiment may be comprised of user equipment, such as a mobile terminal, that includes a processing element configured to determine the length of the idle period, receive a plurality of symbols within the downlink slot and then recognize the symbol including RS at a position within the downlink slot that varies based upon the length of the idle period.

Accordingly, the method, apparatus and computer program product of embodiments of the present invention permit the position of the symbol including RS within a downlink slot to be varied based upon the length of the idle period, thereby accommodating idle periods of different lengths, such as necessitated by differently-sized cells, while still providing the reference signals that are required in order to permit accurate recovery of the data and to avoid any degradation of downlink performance that may otherwise be occasioned by a reduction in the number of reference signals included in the downlink.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic diagram illustrating two slots of a conventional E-UTRAN subframe or transmission time interval (TTI) and, in turn, the seven symbols included in a respective slot;

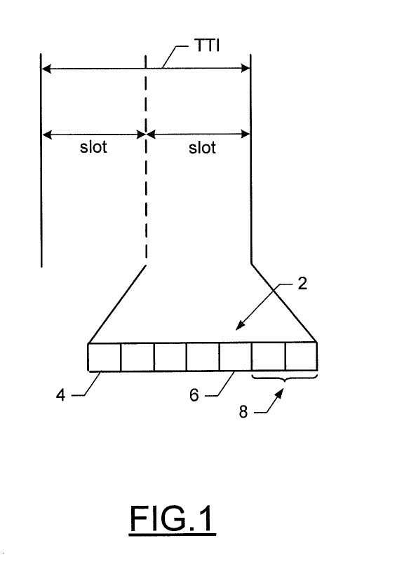

FIG. 2 is a schematic black diagram of the mobile terminal according to an exemplary embodiment to the present invention;

FIG. 3 is a schematic black diagram of the wireless communication system according to an exemplary embodiment of the present invention;

FIG. 4 is a schematic black diagram of a network entity of the wireless communication system of FIG. 2 according to an exemplary embodiment of the present invention;

FIG. 5 is a schematic diagram illustrating two slots of an e-UTRAN subframe or transmission time interval (TTI) and, in turn, the seven symbols included in a respective slot for idle periods having lengths of one symbol, three symbols and five symbols in accordance with an exemplary embodiment of the present invention; and

FIG. 6 is a flowchart depicting the operations performed by the method, apparatus and computer program product in accordance with an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

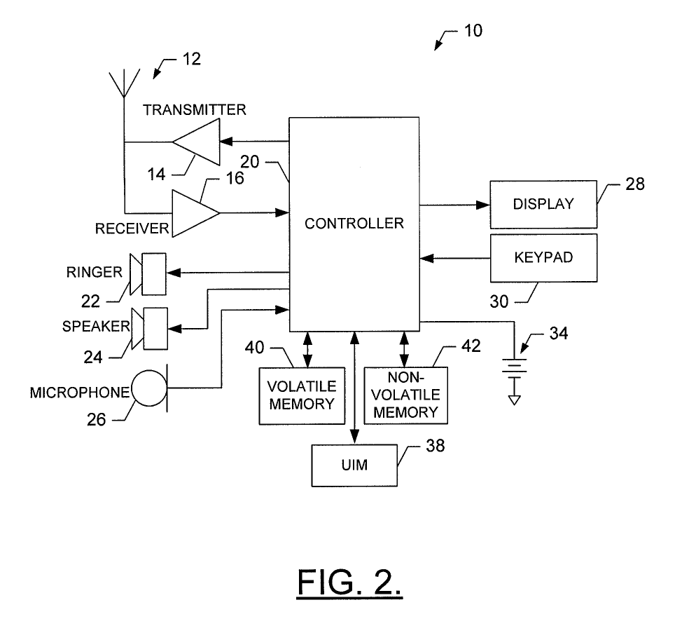

FIG. 2 illustrates a block diagram of a mobile terminal 10 that would benefit from embodiments of the present invention. It should be understood, however, that a mobile telephone as illustrated and hereinafter described is merely illustrative of one type of user equipment that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, LTE or E-UTRAN, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

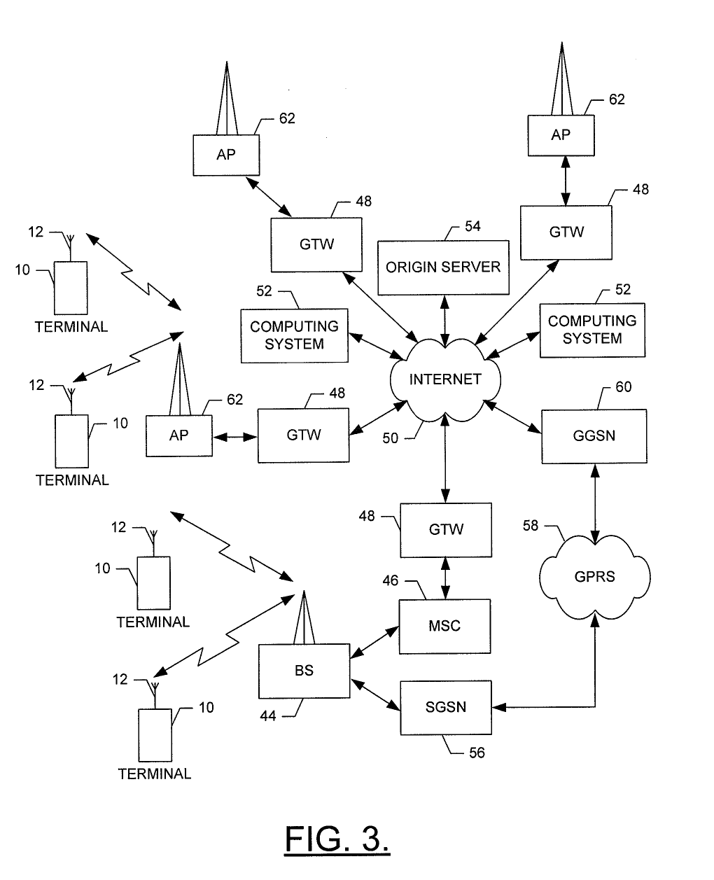

FIG. 3 is a schematic block diagram of a wireless communications system according to an exemplary embodiment of the present invention. Referring now to FIG. 3, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 3, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 3), origin server 54 (one shown in FIG. 3) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as E-UTRAN or a Universal Mobile Telephone System (UMTS) network employing Wideband Code Division Multiple Access (WCDMA) radio access technology. Some narrow-band AMPS (VAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 3, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like.

In an exemplary embodiment, content or data may be communicated over the system of FIG. 3 between a mobile terminal, which may be similar to the mobile terminal 10 of FIG. 2 and a network device of the system of FIG. 3 in order to execute applications for establishing communication between the mobile terminal 10 and other mobile terminals, for example, via the system of FIG. 3. However, it should be understood that the system of FIG. 3 need not be employed for communication between mobile terminals or between a network device and the mobile terminal, but rather FIG. 3 is merely provided for purposes of example.

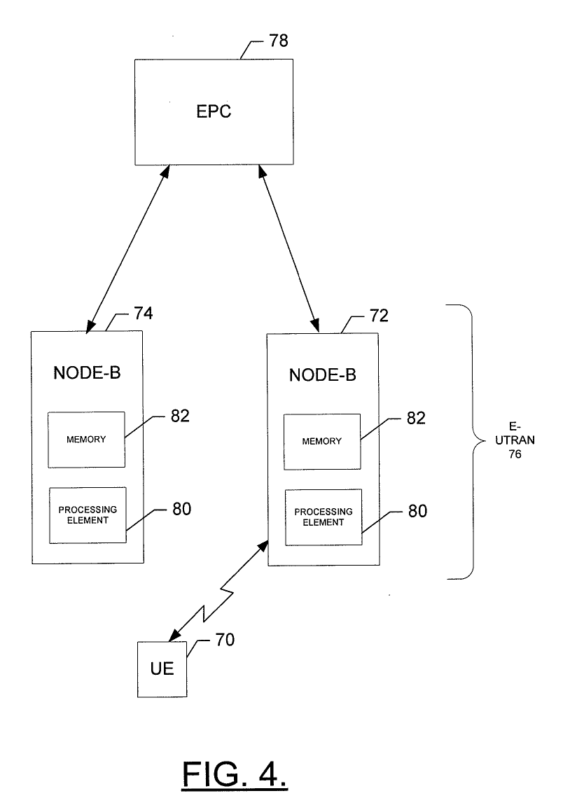

An exemplary embodiment of the invention will now be described with reference to FIG. 4, in which certain elements of a system for facilitating adaptive reference symbol placement are displayed. The system of FIG. 4 represents a specific embodiment of a network such as the general network displayed in FIG. 3, except that FIG. 4 represents a general block diagram of an E-UTRAN. As such, in connection with FIG. 4, user equipment (UE) 70 may be exemplary of one embodiment of the mobile terminal 10 of FIG. 2 and node-B 72 may be exemplary of embodiments of either the BS 44 or AP 62 of FIG. 3. However, it should be noted that the system of FIG. 4, may also be employed in connection with a variety of other devices, both mobile and fixed, and therefore, embodiments of the present invention should not be limited to application on devices such as the mobile terminal 10 of FIG. 2 or the network devices of FIG. 3. Additionally, while the method, apparatus and computer program product of exemplary embodiments of the present invention will be described in conjunction with the E-UTRAN of FIG. 4, the method, apparatus and computer program product of other embodiments may be utilized in conjunction other networks, such as those shown more generically in FIG. 3 including, for example, TTD systems.

Referring now to FIG. 4, a schematic block diagram showing a system for adaptive reference symbol placement according to an exemplary embodiment of the present invention is provided. The system includes an E-UTRAN 76 which may include, among other things, a plurality of Node-Bs in communication with an evolved packet core (EPC) 78 which may include one or more mobility management entities (MMEs) and one or more system architecture evolution (SAE) gateways. The node-Bs may be evolved node-Bs (e.g., eNodeBs) and may also be in communication with the UE 70 and other UEs.

The node-Bs may provide E-UTRA user plane and control plane (radio resource control (RCC)) protocol terminations for the UE 70. The node-Bs may provide functionality hosting for such functions as radio resource management, radio bearer control, radio admission control, connection mobility control, dynamic allocation of resources to UEs in both uplink and downlink, selection of an MME at UE attachment, header compression and encryption, scheduling of paging and broadcast information, routing of data, measurement and measurement reporting for configuration mobility, and the like.

The MME may host functions such as distribution of messages to respective node-Bs, security control, idle state mobility control, SAE bearer control, ciphering and integrity protection of NAS signaling, and the like. The SAE gateway may host functions such as termination and switching of certain packets for paging and support of UE mobility. In an exemplary embodiment, the EPC 78 may provide connection to a network such as the Internet.

In the same fashion as the various network entities and computing devices of the communications system of FIG. 3, the node-Bs may each include a processing element 80 configured to execute functions associated with each corresponding node-B, as shown in FIG. 4. Such functions could be, for example, associated with stored instructions which when executed by the processing element 80 carry out the corresponding functions associated with the instructions. In an exemplary embodiment, each of the node-Bs may also include or otherwise be associated with a memory device, such as random access memory, for storing the aforementioned instructions as well as other data, parameters and the like. A processing element such as those described above may be embodied in many ways. For example, the processing element 80 may be embodied as a processor, a coprocessor, a controller or various other processing means or devices including integrated circuits such as, for example, an ASIC (application specific integrated circuit).

As described above, the symbols that include the RS are defined by E-UTRAN to be included in the first and fifth symbols of a slot in the case of a normal CP or to be included in the first and fourth symbols of a slot in the case of an extended CP. For purposes of discussion, the inclusion of the RS in the first and fifth symbols of a slot in the case of a normal CP will be hereinafter described, although the various embodiments of the present invention are equally applicable in the context of an extended CP in which the RS are generally included in the first and fourth symbols of a slot. As also described above, in instances in which the idle period is longer than two symbols, the last RS will not be provided since the symbol that otherwise would have included the last RS, i.e., the fifth symbol, will be muted in light of the longer idle period, thereby leading to potentially degraded performance as a result of reduced accuracy in the estimation of the channel. Accordingly, the method, apparatus and computer program products of the various embodiments of the present invention include the reference signals in differently positioned symbols within a slot with the location or position of the reference signals being based upon the length of the idle period.

In a wireless communications system, such as the E-UTRAN 76 schematically depicted in FIG. 4, both the base stations, such as the eNodeBs 72, 74, and the user equipment 10, such as the mobile terminals, are advised of the length of the idle period that will proceed a DL-to-UL switch point via the network specific parameters that are broadcast to the user equipment and the other network entities, such as via a broadcast channel (BCH). As such, all base stations and user equipment are aware of the length of the idle period prior to receiving or sending any user-plane data. In this regard, the length of the idle period that precedes the DL-to-UL switch point may be stored in the memory devices 82, 40 associated with the base stations and the user equipment.

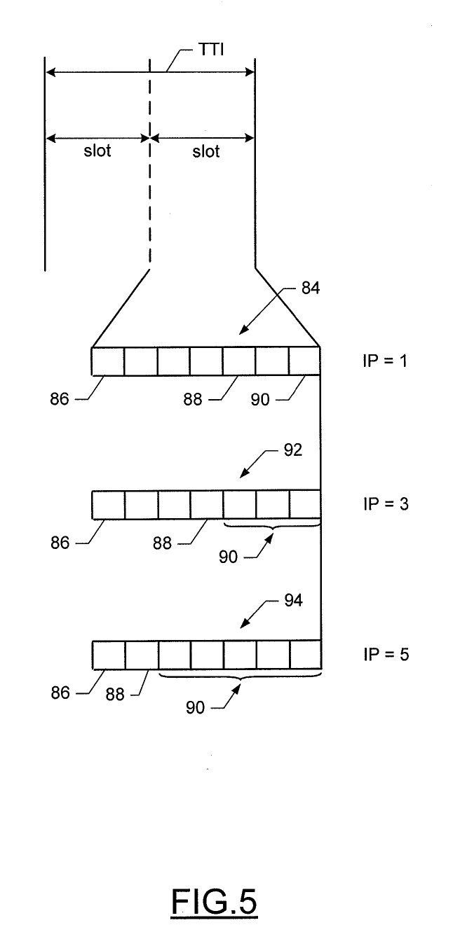

Based upon the length of the idle period, both the base stations 72, 74 and the user equipment 70 can determine the position of the last symbol that will include the RS that is to be transmitted prior to the idle period. In particular, the processing element 80 of the base station can determine the symbol in which to include the last RS prior to the idle period, typically immediately prior to the idle period. Similarly, the processing element 20 of the user equipment can determine the symbol that will include the last RS to precede an idle period in order to permit proper decoding and interpretation of the symbols. In instances in which the idle period length is no more than two symbols, the processing element of the base station will transmit the RS in a conventional manner. In other words, the base station will transmit the RS in the first and fifth symbols of the last slot prior to the DL-to-UL switch point. See, for example, slot 84 in FIG. 5 in which the first and fifth symbols that include the RS are designated 86 and 88, respectively, and the one symbol that is muted for the idle period (IP) is designated 90.

In instances in which the length of the idle period is greater than two symbols, but less than seven symbols, such as idle periods of three symbols in length, four symbols in length, five symbols in length or six symbols in length, the processing element 80 of the base station 72 will include the RS in the last symbol that precedes the idle period. As such, if the idle period is three symbols in length, the processing element would include the last RS for the slot in the fourth symbol as shown in FIG. 5 in conjunction with the slot designated 92. Alternatively, if the idle period is four symbols in length, the processing element of the base station would include the last RS for the slot in the third symbol. If the length of the idle period were five symbols in length, the processing element of the base station would include the last RS for the slot in the second symbol as shown in FIG. 5 in conjunction with the slot designated 94. Further, if the length of the idle period were six symbols in length, the last and, indeed, the only RS for the slot would be included in the first symbol.

As shown in FIG. 5, a system, such as E-UTRAN, which is designed to transmit the RS in two different symbols, such as the first and the fifth symbols, will generally not only include the last RS in the symbol that immediately precedes the idle period as is described above, but also will still include the RS in the first symbol of the slot. In instances in which the length of the idle period is six symbols in length, however, the processing element 80 of the base station 72 would only transmit the RS in the first symbol since the first symbol is not only the first symbol of the slot, but also the last symbol that precedes the idle period. It is noted that if a wireless communication system required the RS to be included in two symbols of a slot, idle periods of six or more symbols would effectively consume an entire slot since there would not be two non-idle period symbols remaining that could include the first and the last RS.

Since the user equipment 70 is also aware of the length of the idle period, the user equipment and, in particular, the processing element 20 of the user equipment will be able to determine the symbols that include the RS even though the symbol that includes the last RS of the slot may be located in different positions within the slot depending on the length of the idle period. Accordingly, the signals received by the user equipment can contain the same amount of RS even in instances in which the idle period is three symbols, four symbols or five symbols in length such that the user equipment can therefore recover the data with the same degree of accuracy as in instances in which the idle period is shorter.

While the method, apparatus and computer program product has been described above in conjunction with an E-UTRA system designed to provide the RS in the first and fifth symbols of a slot, the method, apparatus and computer program product of other embodiments of the present invention can also be employed in conjunction with other systems that are designed to include RS in one or more symbols of a slot with the position of the symbol that includes the last RS of the slot being adaptively positioned based upon the length of the idle period such that the symbol including the last RS of the slot is prior to, such as immediately prior to, the idle period.

By adaptively positioning the symbol that includes the last RS of the slot in a manner that varies based upon the length of the idle period, the method, apparatus, computer program product of embodiments of the present invention can accommodate idle periods of various lengths while still maintaining at least the same performance and accuracy in channel estimation as enjoyed during transmission via a downlink slot that does not include any idle period symbols. Additionally, as both the base stations and the user equipment are aware of the length of the idle period, no additional signaling bits are generally required to configure the base stations and the user equipment for embodiments of the present invention. As such, the method, apparatus, and computer program product permit longer idle periods to be accommodated, thereby avoiding undesirable interference even in relatively large cells.

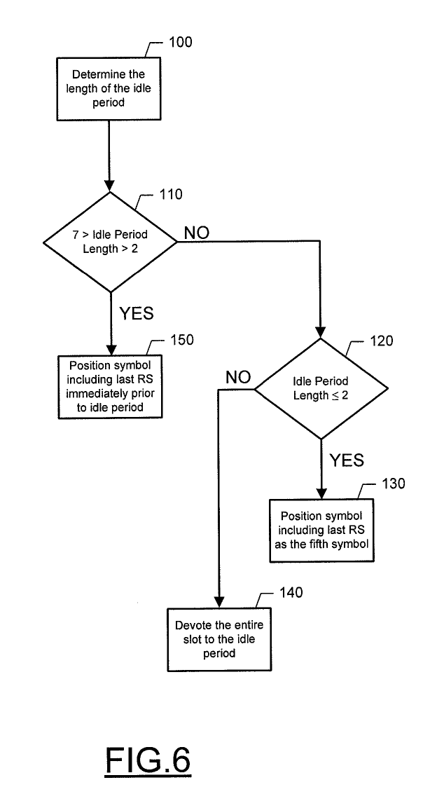

FIG. 6 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal and/or a base station and executed by the corresponding processing element of the mobile terminal and/or the base station. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for adaptively placing reference symbols includes an initial determination of the length of the idle period, such as based upon network parameters provided via the broadcast channel, at operation 100. For purposes of example but not of limitation, consider an embodiment in which a slot includes seven symbols, there is no requirement that at least two different symbols of a slot include the RS and the last RS of the slot is typically included in the fifth symbol of a slot. In this embodiment, a decision is initially made at operation 110 as to whether the length of the idle period is more than two symbols and is less than seven symbols in length. If the length of the idle period is not more than two symbols and less than seven symbols in length, another determination is made at operation 120 as to whether the length of the idle period is zero, one or two symbols in length. If the length of the idle period is zero, one or two symbols in length, the last RS that precedes the idle period is included in the fifth symbol of the slot, as noted by operation 130. If, however, the length of the idle period is seven symbols or more in length, the entire slot is devoted to the idle period with each symbol being thereby muted, as indicated by operation 140. Alternatively, if the length of the idle period is determined to be greater than two symbols in length and less than seven symbols in length, the last RS of the slot is placed in the symbol immediately preceding the idle period as described above and as indicated by operation 150. In other embodiments, the number of symbols per slot may be different, the minimum number, if any of the symbols of a slot that must include the RS may be different and the typical position of the symbol that includes the last RS of the slot may vary, but the method, apparatus and computer program products may still similarly adjust the position of the symbol containing the last RS of the slot based upon the length of the idle period as described above. While the above-described method for adaptively placing reference symbols may be performed by a base station, a corresponding method for determining the placement of the reference symbols and subsequently appropriately interpreting the signals received by the user equipment, such as a mobile terminal, is also provided.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1-24. (canceled)

25. A method comprising:
determining a length of an idle period; and
identifying a position of a symbol that includes a reference signal within a slot based upon the length of the idle period.

26. The method according to claim 25 further comprising:
determining a number of symbols that include reference signals that fit in the slot based on the length of the idle period and a length of the slot; and
wherein identifying said position of a symbol that included a reference signal comprises identifying positions for said number of symbols that include reference signals such that said positions occur within the slot prior to the idle period.

27. The method according to claim 26 wherein the number of symbols that include reference signals is at most two.

28. The method according to claim 25 wherein said position is identified to occur immediately prior to the idle period.

29. The method according to claim 25 further comprising:
receiving a plurality of symbols within said slot.

30. The method according to claim 25 further comprising:
inserting said symbol at said identified position within said slot.

31. The method according to claim 30 further comprising:
transmitting said slot.

32. An apparatus comprising:
at least one processor and at least one memory including computer program code
the at least one memory and the computer program code configured to, with the at least one processor, cause the apparatus at least to:
determine a length of an idle period; and
identify a position of a symbol that includes a reference signal within a slot based upon the length of the idle period.

33. The apparatus according to claim 32 wherein the at least one memory and the computer program code further configured to, with the at least one processor, cause the apparatus at least to:
determine a number of symbols that include reference signals that fit in the slot based on the length of the idle period and a length of the slot; and
identify said position of the symbol that include a reference signal by identifying positions for said determined number of symbols that include reference signals such that said positions occur within the slot prior to the idle period.

34. The apparatus according to claim 33 wherein the number of symbols that include reference signals is at most two symbols.

35. The apparatus according to claim 32 wherein the at least one memory and the computer program code configured to, with the at least one processor, cause the apparatus at least to identify said position of the symbol that includes a reference signal to be located immediately prior to the idle period.

36. The apparatus according to claim 32 further comprising:
a receiver for receiving a plurality of symbols within said slot.

37. The apparatus according to claim 32 wherein the at least one memory and the computer program code configured to, with the at least one processor, cause the apparatus at least to further:
insert said symbol that includes a reference signal at said identified position within said slot.

38. The apparatus according to claim 37 further comprising:
a transmitter for transmitting said slot.

39. A computer program product comprising a computer-readable medium bearing computer program code embodied therein for use with a computer, the computer program code comprising:
a first executable portion configured to determine a length of an idle period; and
a second executable portion configured to identify the position of a symbol that includes a reference signal within a slot based upon the length of the idle period.

40. The computer-readable storage medium according to claim 39 further comprising:
a third executable portion configured to determine a number of symbols that include reference signals that fit in the slot based on the length of the idle period and a length of the slot; and
wherein the second executable portion is further configured to identify positions for said number of symbols that include reference signals such that said positions occur within the slot occur prior to the idle period.

41. The computer-readable storage medium according to claim 39 wherein the number of symbols that include reference signals is at most two symbols.

42. The computer-readable storage medium according to claim 39 wherein said position of a symbol that includes a reference signal is identified to occur immediately prior to the idle period.
